(19) United States
(12) Patent Application Publication
(10) Pub. No.: US 2015/0059161 A1
(43) Pub. Date: Mar. 5, 2015

(54) TOUCH PANEL PRODUCING METHOD

(71) Applicant: Primax Electronics Ltd., Taipei (TW)

(72) Inventor: HSIN-YI HO, Taipei (TW)

(73) Assignee: Primax Electronics Ltd., Taipei (TW)

(21) Appl. No.: 14/092,402

(22) Filed: Nov. 27, 2013

(30) Foreign Application Priority Data
Aug. 30, 2013 (TW) 102131350
Sep. 13, 2013 (TW) 102133273

(51) Int. Cl. G06F 3/041

(52) U.S. Cl. CPC G06F 3/041
USPC 29/593; 29/592.1

(57) ABSTRACT

A touch panel producing method includes the following steps. Firstly, a first coiled sheet and a second coiled sheet are transferred in a specified direction. Then, the first coiled sheet and the second coiled sheet are laminated together. Then, a laminated structure of the first coiled sheet and the second coiled sheet is cut, so that a sensing plate section is produced. Then, the sensing plate section is removed from the laminated structure of the first coiled sheet and the second coiled sheet, so that a sensing plate is produced. Afterwards, a touch control circuit board is attached on the sensing plate. The first coiled sheet includes plural sensing regions. The second coiled sheet is an adhesive sheet. The sensing plate section includes one of the plural sensing regions.

### FIELD OF THE INVENTION

The present invention relates to a touch panel producing method, and more particularly to an automatic touch panel producing method.

### BACKGROUND OF THE INVENTION

Nowadays, according to the touch sensing methods, touch panels are classified into several types, including resistive touch panels, capacitive touch panels, optical touch panels, electromagnetic touch panels, acoustic wave touch panels, or the like. For example, when a surface of a capacitive touch panel is touched by a user's finger or a stylus pen, the voltage and the current corresponding to the touch position are subject to changes. According to the changes of the voltage and the current, the touch position of the surface of the touch panel is detected. Consequently, a touch input purpose is achieved.

Generally, the capacitive touch panel consists of an adhesive sheet and a transparent substrate attached on the adhesive sheet, wherein the transparent substrate is coated with an x-direction transparent conductor electrode and a y-direction transparent conductor electrode. Alternatively, the capacitive touch panel is a stack structure comprising a transparent substrate, a first adhesive sheet, a light guide plate and a second adhesive sheet, wherein the transparent substrate is attached on the light guide plate through the first adhesive sheet and then the light guide plate is attached on the second adhesive sheet.

Since the stack structure is very complicated, some drawbacks may occur. For example, during the process of fabricating the stack structure, many layers of adhesive sheets are used and many bonding and aligning steps are required. In addition, since the conventional bonding and aligning steps are manually performed, foreign matters are readily introduced into the stack structure. Moreover, due to some human factors, the production yield is usually unsatisfied, and the production stability is adversely affected.

Therefore, there is a need of providing an improved touch panel producing method in order to overcome the above drawbacks.

### SUMMARY OF THE INVENTION

An object of the present invention provides a touch panel producing method without the manual attaching procedures.

In accordance with an aspect of the present invention, there is provided a touch panel producing method. Firstly, a first coiled sheet and a second coiled sheet are transferred in a specified direction. The first coiled sheet includes plural sensing regions, and the second coiled sheet is an adhesive sheet. Then, the first coiled sheet and the second coiled sheet are laminated together. Then, a laminated structure of the first coiled sheet and the second coiled sheet is cut, so that a sensing plate section is produced. The sensing plate section includes one of the plural sensing regions. Then, the sensing plate section is removed from the laminated structure of the first coiled sheet and the second coiled sheet, so that a sensing plate is produced. Afterwards, a touch control circuit board is attached on the sensing plate.

In accordance with an aspect of the present invention, there is provided a touch panel producing method. Firstly, a first coiled sheet, a second coiled sheet, a third coiled sheet and a fourth coiled sheet are transferred in a specified direction, and the first coiled sheet, the second coiled sheet, the third coiled sheet and the fourth coiled sheet are laminated together. The first coiled sheet is attached on the second coiled sheet, the second coiled sheet is attached on the third coiled sheet, and the third coiled sheet is attached on the fourth coiled sheet. The first coiled sheet includes plural sensing regions. The second coiled sheet and the fourth coiled sheet are adhesive sheets. The third coiled sheet is a light guide plate. Then, a laminated structure of the first coiled sheet, the second coiled sheet, the third coiled sheet and the fourth coiled sheet is cut, so that a sensing plate section is produced. The sensing plate section includes one of the plural sensing regions. Then, the sensing plate section is removed from the laminated structure of the first coiled sheet, the second coiled sheet, the third coiled sheet and the fourth coiled sheet, so that a sensing plate is produced. Afterwards, a touch control circuit board is attached on the sensing plate.

In accordance with another aspect of the present invention, there is provided a touch panel producing method. Firstly, a first coiled sheet and a second coiled sheet are transferred in a specified direction. The first coiled sheet includes plural sensing regions, and the second coiled sheet is an adhesive sheet. Then, the first coiled sheet and the second coiled sheet are laminated together. Then, a touch control circuit board is attached on the first coiled sheet. Then, a laminated structure of the first coiled sheet and the second coiled sheet is cut, so that a sensing plate section is produced. The sensing plate section includes one of the plural sensing regions and the touch control circuit board. Afterwards, the sensing plate section is removed from the laminated structure of the first coiled sheet and the second coiled sheet, so that a sensing plate is produced.

In accordance with an aspect of the present invention, there is provided a touch panel producing method. Firstly, a first coiled sheet, a second coiled sheet, a third coiled sheet and a fourth coiled sheet are transferred in a specified direction, and the first coiled sheet, the second coiled sheet, the third coiled sheet and the fourth coiled sheet are laminated together. The first coiled sheet is attached on the second coiled sheet, the second coiled sheet is attached on the third coiled sheet, and the third coiled sheet is attached on the fourth coiled sheet. The first coiled sheet includes plural sensing regions. The second coiled sheet and the fourth coiled sheet are adhesive sheets. The third coiled sheet is a light guide plate. Then, a touch control circuit board is attached on the first coiled sheet. Then, a laminated structure of the first coiled sheet, the second coiled sheet, the third coiled sheet and the fourth coiled sheet is cut, so that a sensing plate section is produced. The sensing plate section includes one of the plural sensing regions and the touch control circuit board. Afterwards, the sensing plate section is removed from the laminated structure of the first coiled sheet, the second coiled sheet, the third coiled sheet and the fourth coiled sheet, so that a sensing plate is produced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a touch panel producing apparatus for implementing a touch panel producing method according to a first embodiment of the present invention;

FIG. 2 schematically illustrates the structure of a first coiled sheet used in the touch panel producing method according to the first embodiment of the present invention;

FIG. 3 schematically illustrates a flowchart of the touch panel producing method according to a first embodiment of the present invention;

FIG. 4 schematically illustrates a sensing plate section generated in the touch panel producing method according to the first embodiment of the present invention;

FIG. 5 schematically illustrates a sensing plate produced in the touch panel producing method according to the first embodiment of the present invention;

FIG. 6 schematically illustrates the combination of the sensing plate and a touch control circuit board produced in the touch panel producing method according to the first embodiment of the present invention;

FIG. 7 schematically illustrates the combination of the sensing plate, the touch control circuit board and a display panel produced in the touch panel producing method according to the first embodiment of the present invention;

FIG. 8 schematically illustrates a touch panel producing apparatus for implementing a touch panel producing method according to a second embodiment of the present invention;

FIG. 9 schematically illustrates a flowchart of the touch panel producing method according to a second embodiment of the present invention;

FIG. 10 schematically illustrates a sensing plate section generated in the touch panel producing method according to the second embodiment of the present invention;

FIG. 11 schematically illustrates a sensing plate produced in the touch panel producing method according to the second embodiment of the present invention;

FIG. 12 schematically illustrates the combination of the sensing plate and a touch control circuit board produced in the touch panel producing method according to the second embodiment of the present invention;

FIG. 13 schematically illustrates the combination of the sensing plate, the touch control circuit board and a glass plate produced in the touch panel producing method according to the second embodiment of the present invention;

FIG. 14 schematically illustrates a touch panel producing apparatus for implementing a touch panel producing method according to a third embodiment of the present invention;

FIG. 15 schematically illustrates a touch panel producing apparatus for implementing a touch panel producing method according to a fourth embodiment of the present invention;

FIG. 16 schematically illustrates a touch panel producing apparatus for implementing a touch panel producing method according to a fifth embodiment of the present invention;

FIG. 17 schematically illustrates a touch panel producing apparatus for implementing a touch panel producing method according to a sixth embodiment of the present invention;

FIG. 18 schematically illustrates a flowchart of the touch panel producing method according to a sixth embodiment of the present invention;

FIG. 19 schematically illustrates a sensing plate section generated in the touch panel producing method according to the sixth embodiment of the present invention;

FIG. 20 schematically illustrates a touch panel producing apparatus for implementing a touch panel producing method according to a seventh embodiment of the present invention;

FIG. 21 schematically illustrates a flowchart of the touch panel producing method according to a seventh embodiment of the present invention; and

FIG. 22 schematically illustrates a sensing plate section generated in the touch panel producing method according to the seventh embodiment of the present invention.

### DETAILED DESCRIPTION OF THE PREFERRED EMBODIMENT

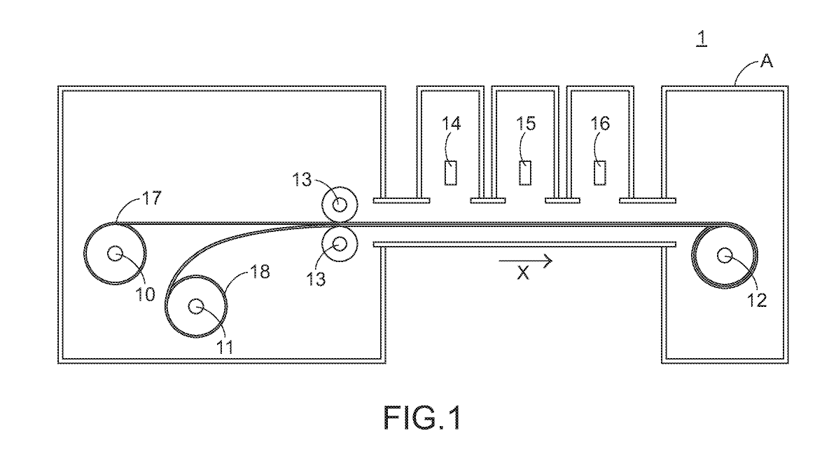

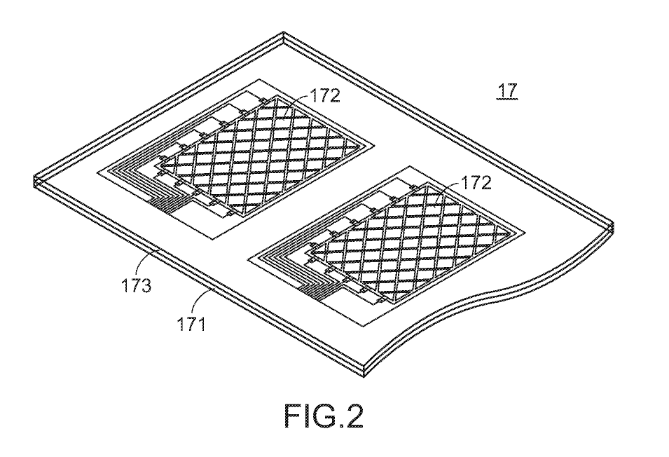

First of all, a touch panel producing method according to a first embodiment of the present invention will be illustrated with reference to FIGS. 1 and 2. All of the steps of the touch panel producing method are implemented in a clean room A. FIG. 1 schematically illustrates a touch panel producing apparatus for implementing a touch panel producing method according to a first embodiment of the present invention. FIG. 2 schematically illustrates the structure of a first coiled sheet used in the touch panel producing method according to the first embodiment of the present invention. As shown in FIGS. 1 and 2, the touch panel producing apparatus 1 comprises a first shaft 10, a second shaft 11, a take-up roll 12, a first roller assembly 13, a cutting device 14, a washing device 15, and a removing device 16.

A first coiled sheet 17 is sheathed around the first shaft 10. As shown in FIG. 2, the first coiled sheet 17 comprises a plastic substrate 171, plural sensing regions 172, and a thin film 173. The plural sensing regions 172 are formed on a first surface of the plastic substrate 171. The thin film 173 is disposed on a second surface of the plastic substrate 171. In this embodiment, each of the plural sensing regions 172 is made of nano carbon tube, nano silver, graphene or any other appropriate touch control circuit material, but is not limited thereto. The thin film 173 is an explosion-proof film, a scratch-resistant film, an anti-glare film or any other appropriate transparent film, but is not limited thereto. The plastic substrate 171 is made of a transparent plastic material such as polycarbonate (PC), polymethylmethacrylate (PMMA) or polyethylene terephthalate (PET), but is not limited thereto.

It is noted that the plural sensing regions 172 of FIG. 2 are presented herein for purpose of illustration and description only. That is, the arrangements, the constitutions and the electrode circuit patterns of the plural sensing regions 172 are not restricted. Alternatively, in another embodiment, the thin film 173 on the second surface of the plastic substrate 171 is omitted. Alternatively, in a further embodiment, plural thin films 173 with different functions are disposed on the second surface of the plastic substrate 171.

Please refer to FIG. 1 again. A second coiled sheet 18 is sheathed around the second shaft 11. The second shaft 11 is disposed below the first shaft 10. In this embodiment, the second coiled sheet 18 is an adhesive sheet such as an optically-clear adhesive sheet (OCA sheet) or a pressure-sensitive adhesive sheet (PSA sheet), but is not limited thereto. In some other embodiments, the second coiled sheet 18 is made of other sticky material.

The first roller assembly 13, the cutting device 14, the washing device 15, the removing device 16 and the take-up roll 12 are sequentially arranged downstream of the first shaft 10 and the second shaft 11. An example of the cutting device 14 includes but is not limited to a laser cutting machine, a die cutting machine or a hob cutting machine. An example of the washing device 15 includes but is not limited to a dry cleaning machine or a wet cleaning machine. The removing device 16 is a robotic arm, but is not limited thereto.

It is noted that the components of the touch panel producing apparatus 1 as shown in the drawings are presented herein for purpose of illustration and description only. That is, the constituents of the touch panel producing apparatus 1 and the positions of all components may be varied according to the practical requirements.

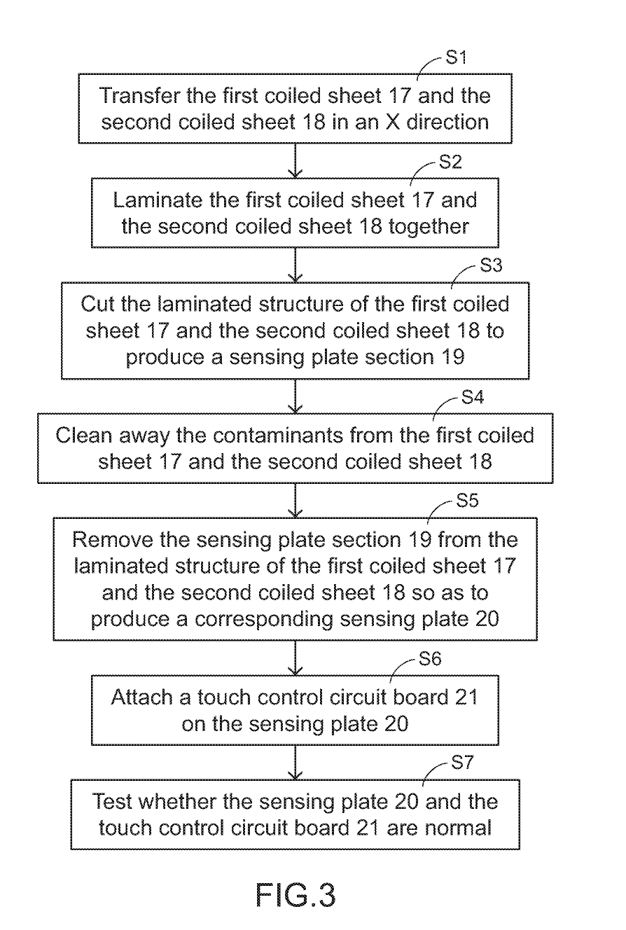

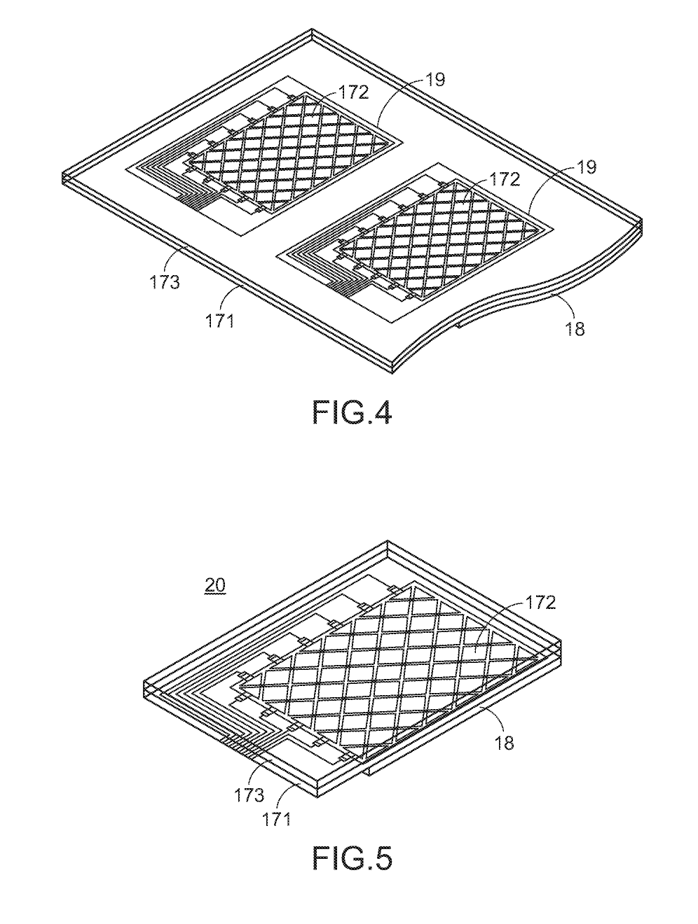

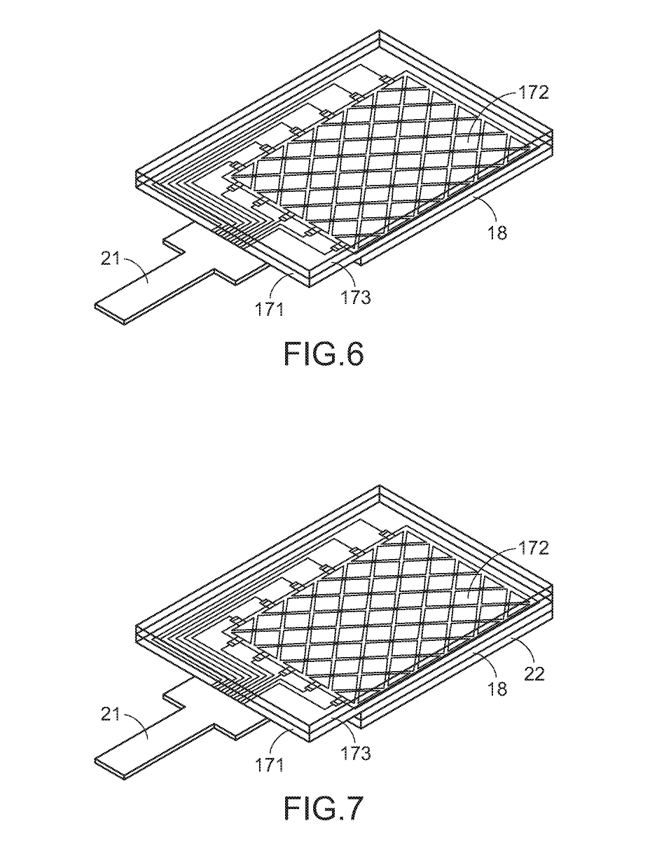

Hereinafter, the operations of the touch panel producing method according to the first embodiment of the present invention will be illustrated with reference to FIGS. 3, 4, 5 and 6. FIG. 3 schematically illustrates a flowchart of the touch panel producing method according to a first embodiment of the present invention. FIG. 4 schematically illustrates a sensing plate section generated in the touch panel producing method according to the first embodiment of the present invention. FIG. 5 schematically illustrates a sensing plate produced in the touch panel producing method according to the first embodiment of the present invention. FIG. 6 schematically illustrates the combination of the sensing plate and a touch control circuit board produced in the touch panel producing method according to the first embodiment of the present invention.

After the first coiled sheet 17 is sheathed around the first shaft 10 and the second coiled sheet 18 is sheathed around the second shaft 11, the first shaft 10 and the second shaft 11 are rotated to transfer the first coiled sheet 17 and the second coiled sheet 18 in an X direction (Step S1). It is noted that the sequence of transferring the first coiled sheet 17 and the second coiled sheet 18 is not restricted.

Then, the first coiled sheet 17 and the second coiled sheet 18 are transported across the first roller assembly 13. By the first roller assembly 13, the first coiled sheet 17 is bonded onto the second coiled sheet 18, so that the first coiled sheet 17 and the second coiled sheet 18 are laminated together (Step S2). Then, a laminated structure of the first coiled sheet 17 and the second coiled sheet 18 is wound around and collected by the take-up roll 12. In this embodiment, the thin film 173 is disposed on the second surface of the plastic substrate 171, so that the first surface of the plastic substrate 171 with the plural sensing regions 172 is bonded onto the second coiled sheet 18. In case that no thin film 173 is disposed on the second surface of the plastic substrate 171, the first surface or the second surface of the plastic substrate 171 may be bonded onto the second coiled sheet 18.

As the first shaft 10 and the second shaft 11 are continuously rotated, the laminated structure of the first coiled sheet 17 and the second coiled sheet 18 is transferred in the X direction. When the laminated structure of the first coiled sheet 17 and the second coiled sheet 18 is moved to the cutting device 14, the laminated structure of the first coiled sheet 17 and the second coiled sheet 18 is cut by the cutting device 14. Consequently, a sensing plate section 19 that is detachable from the other part of the laminated structure of the first coiled sheet 17 and the second coiled sheet 18 is generated (Step S3). As shown in FIG. 4, the sensing plate section 19 comprises a part of the first coiled sheet 17 containing the sensing region 172 and a part of the second coiled sheet 18 attached on the first coiled sheet 17. It is noted that the shape of the sensing plate section 19 is not restricted. According to the practical requirements, the sensing plate section 19 with any desired shape may be cut by the cutting device 14. Moreover, the profiles and the sizes of the first coiled sheet 17 and the second coiled sheet 18 as shown in FIG. 4 are presented herein for purpose of illustration and description only and are not restricted.

As the first shaft 10 and the second shaft 11 are continuously rotated, the laminated structure of the first coiled sheet 17 and the second coiled sheet 18 is transferred in the X direction. When the laminated structure of the first coiled sheet 17 and the second coiled sheet 18 is moved to the washing device 15, the contaminants (e.g. dust) which are occurred at the time of cutting task and retained on the first coiled sheet 17 and the second coiled sheet 18 are cleaned away by the washing device 15 (Step S4).

After the washing task is completed, the first shaft 10 and the second shaft 11 are continuously rotated to transfer the laminated structure of the first coiled sheet 17 and the second coiled sheet 18 in the X direction. When the laminated structure of the first coiled sheet 17 and the second coiled sheet 18 is moved to the removing device 16, the sensing plate section 19 is removed from the laminated structure of the first coiled sheet 17 and the second coiled sheet 18. After the sensing plate section 19 is removed, a corresponding sensing plate 20 is produced (Step S5). The sensing plate 20 is shown in FIG. 5.

Then, the sensing plate 20 is transmitted from the removing device 16 to a platform (not shown). Then, a touch control circuit board 21 is attached on the sensing plate 20 at a part of the first coiled sheet 17 (see Step S6 and FIG. 6). Consequently, the touch control circuit board 21 and the sensing region 172 are electrically connected with each other. In this embodiment, the touch control circuit board 21 is a flexible printed circuit board (FPC). In addition, the touch control circuit board 21 may be attached on the sensing plate 20 through an anisotropic conductive film (ACF) or any other appropriate adhesive sheet.

In this embodiment, the step S6 is performed by an automatic device such as a robotic arm, but is not limited thereto. Moreover, the type of the touch control circuit board 21 is not restricted. The touch control circuit board 21 as shown in the drawings is presented herein for purpose of illustration and description only.

Then, the step S7 is performed to move the sensing plate 20 and the touch control circuit board 21 to another platform and test whether the sensing plate 20 and the touch control circuit board 21 are normal.

FIG. 7 schematically illustrates the combination of the sensing plate, the touch control circuit board and a display panel produced in the touch panel producing method according to the first embodiment of the present invention. If the test result is qualified, a bonding surface of the sensing plate 20 (e.g. a part of the second coiled sheet 18) is attached on a display panel 22. An example of the display panel 22 includes but is not limited to a liquid crystal display panel, an electronic paper display panel or a flexible display panel.

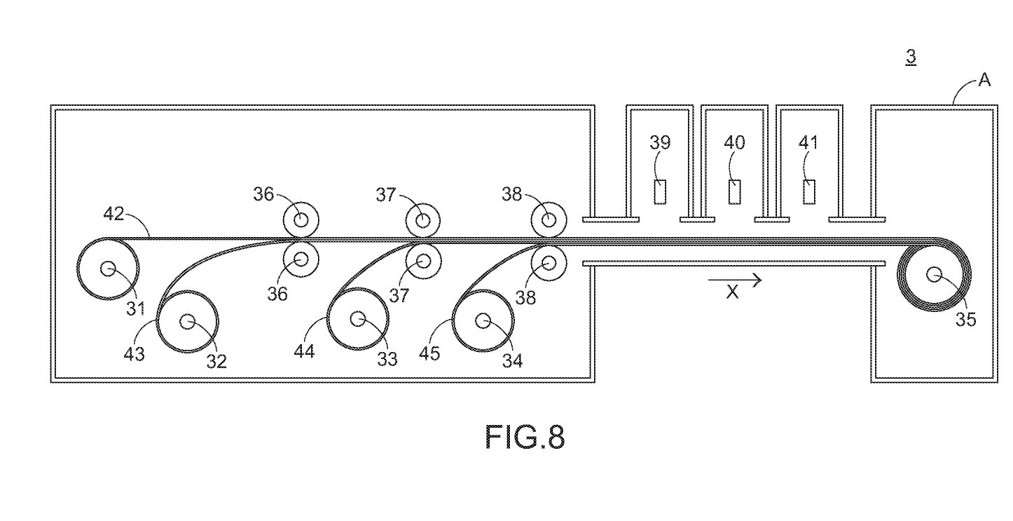

Hereinafter, a touch panel producing method according to a second embodiment of the present invention will be illustrated with reference to FIG. 8. All of the steps of the touch panel producing method are implemented in a clean room A. FIG. 8 schematically illustrates a touch panel producing apparatus for implementing a touch panel producing method according to a second embodiment of the present invention. As shown in FIG. 8, the touch panel producing apparatus 3 comprises a first shaft 31, a second shaft 32, a third shaft 33, a fourth shaft 34, a take-up roll 35, a first roller assembly 36, a second roller assembly 37, a third roller assembly 38, a cutting device 39, a washing device 40, and a removing device 41.

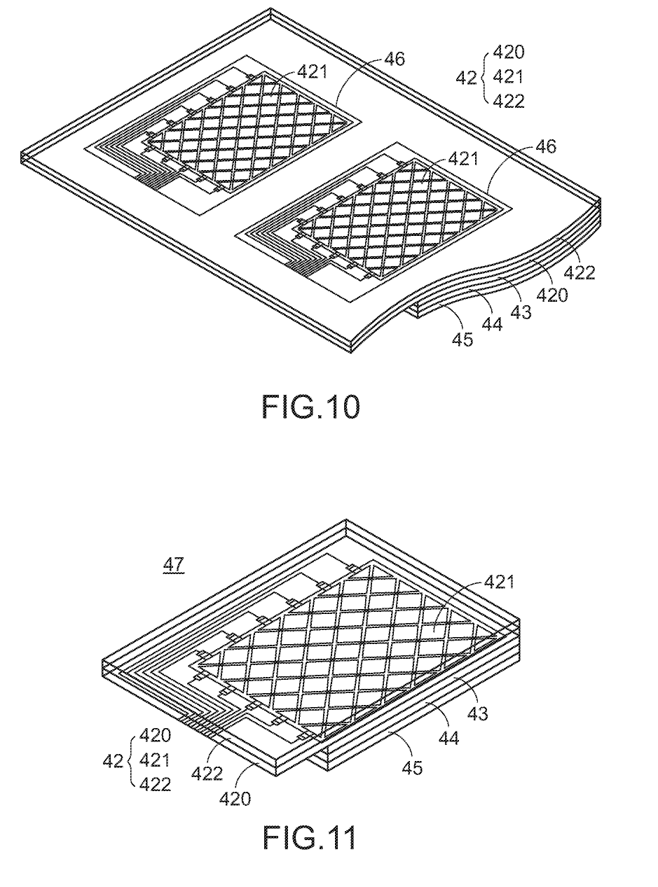

A first coiled sheet 42 is sheathed around the first shaft 31. A second coiled sheet 43 is sheathed around the second shaft 32. The first coiled sheet 42 comprises a plastic substrate 420, plural sensing regions 421, and a thin film 422. The plural sensing regions 421 are formed on a first surface of the plastic substrate 420, and the thin film 422 is disposed on a second surface of the plastic substrate 420 (see FIG. 10). The structures of the first coiled sheet 42 and the second coiled sheet 43 of this embodiment are identical to those of the first coiled sheet 17 and the second coiled sheet 18 of the first embodiment, and are not redundantly described herein.

Moreover, a third coiled sheet 44 is sheathed around the third shaft 33. The third coiled sheet 44 is a light guide plate. The third coiled sheet 44 is made of polycarbonate (PC), polymethylmethacrylate (PMMA), polyethylene terephthalate (PET) or silicon resin, but is not limited thereto.

A fourth coiled sheet 45 is sheathed around the fourth shaft 34. In this embodiment, the fourth coiled sheet 45 is an adhesive sheet such as an optically-clear adhesive sheet (OCA sheet) or a liquid optically-clear adhesive sheet (LOCA sheet), but is not limited thereto. In some other embodiments, the fourth coiled sheet 45 is made of other sticky material.

The first roller assembly 36 is arranged downstream of the first shaft 31 and the second shaft 32. The second roller assembly 37 is arranged downstream of the third shaft 33. The third roller assembly 38 is arranged downstream of the fourth shaft 34. The cutting device 39, the washing device 40, the removing device 41 and the take-up roll 35 are sequentially arranged downstream of the third roller assembly 38. The structures and the functions of the cutting device 39, the washing device 40 and the removing device 41 of this embodiment are identical to those of the cutting device 14, the washing device 15 and the removing device 16 of the first embodiment, and are not redundantly described herein.

It is noted that the components of the touch panel producing apparatus 3 as shown in the drawings are presented herein for purpose of illustration and description only. That is, the constituents of the touch panel producing apparatus 3 and the positions of all components may be varied according to the practical requirements.

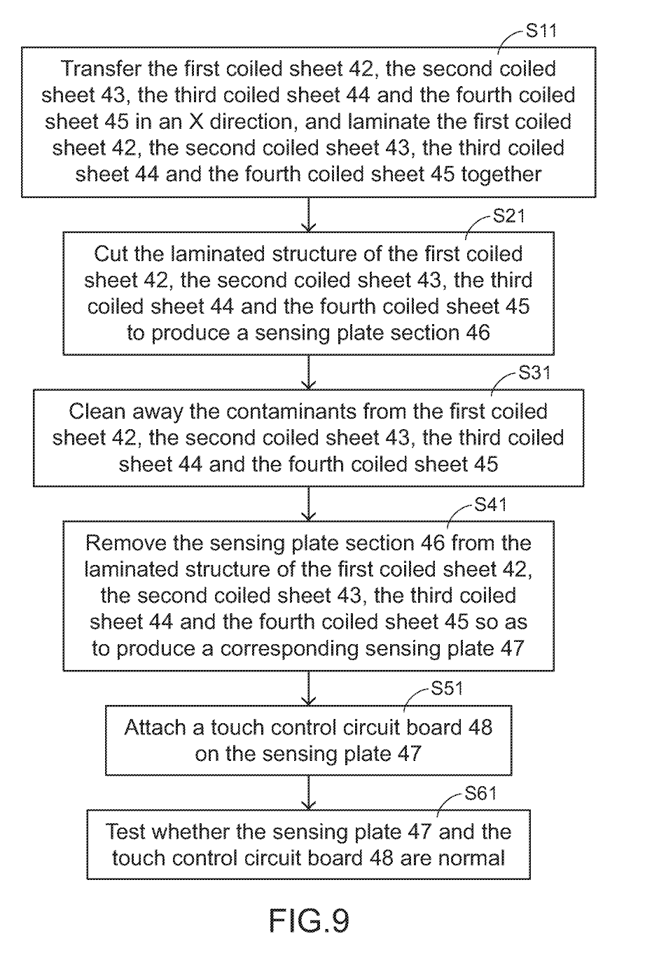

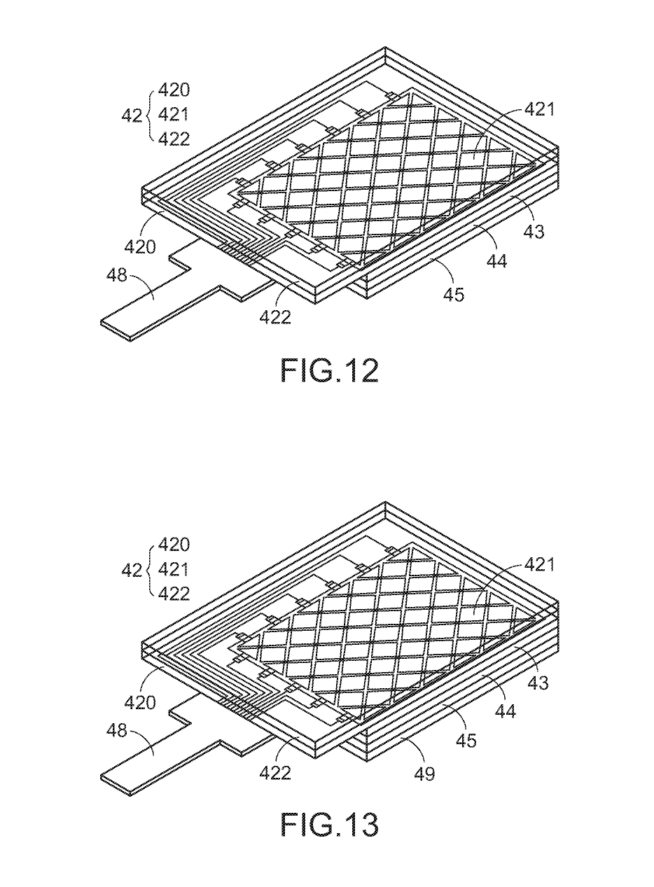

Hereinafter, the operations of the touch panel producing method according to the second embodiment of the present invention will be illustrated with reference to FIGS. 9, 10, 11 and 12. FIG. 9 schematically illustrates a flowchart of the touch panel producing method according to a second embodiment of the present invention. FIG. 10 schematically illustrates a sensing plate section generated in the touch panel producing method according to the second embodiment of the present invention. FIG. 11 schematically illustrates a sensing plate produced in the touch panel producing method according to the second embodiment of the present invention. FIG. 12 schematically illustrates the combination of the sensing plate and a touch control circuit board produced in the touch panel producing method according to the second embodiment of the present invention.

Firstly, the step S11 is performed. After the first coiled sheet 42, the second coiled sheet 43, the third coiled sheet 44 and the fourth coiled sheet 45 are sheathed around the first shaft 31, the second shaft 32, the third shaft 33 and the fourth shaft 34, respectively, the first shaft 31, the second shaft 32, the third shaft 33 and the fourth shaft 34 are rotated to transfer the first coiled sheet 42, the second coiled sheet 43, the third coiled sheet 44 and the fourth coiled sheet 45 in an X direction. Then, the first coiled sheet 42 and the second coiled sheet 43 are transported across the first roller assembly 36. By the first roller assembly 36, the first coiled sheet 42 is bonded onto the second coiled sheet 43, so that the first coiled sheet 42 and the second coiled sheet 43 are laminated together. Then, a laminated structure of the first coiled sheet 42 and the second coiled sheet 43 is transported across the second roller assembly 37, and the third coiled sheet 44 is also transported across the second roller assembly 37. By the second roller assembly 37, the third coiled sheet 44 is bonded onto the second coiled sheet 43, so that the first coiled sheet 42, the second coiled sheet 43 and the third coiled sheet 44 are laminated together. Then, the laminated structure of the first coiled sheet 42, the second coiled sheet 43 and the third coiled sheet 44 is transported across the third roller assembly 38, and the fourth coiled sheet 45 is also transported across the third roller assembly 38. By the third roller assembly 38, the fourth coiled sheet 45 is bonded onto the third coiled sheet 44, so that the first coiled sheet 42, the second coiled sheet 43, the third coiled sheet 44 and the fourth coiled sheet 45 are laminated together. Then, a laminated structure of the first coiled sheet 42, the second coiled sheet 43, the third coiled sheet 44 and the fourth coiled sheet 45 is wound around and collected by the take-up roll 35.

When the laminated structure of the first coiled sheet 42, the second coiled sheet 43, the third coiled sheet 44 and the fourth coiled sheet 45 is moved in the direction X to the cutting device 39, the laminated structure of the first coiled sheet 42, the second coiled sheet 43, the third coiled sheet 44 and the fourth coiled sheet 45 is cut by the cutting device 39. Consequently, a sensing plate section 46 that is detachable from other parts of the laminated structure of the first coiled sheet 42, the second coiled sheet 43, the third coiled sheet 44 and the fourth coiled sheet 45 is generated (Step S21). As shown in FIG. 10, the sensing plate section 46 comprises a part of the first coiled sheet 42 containing the sensing region 421, a part of the second coiled sheet 43 attached on the first coiled sheet 42, a part of the third coiled sheet 44 attached on the second coiled sheet 43 and a part of the fourth coiled sheet 45 attached on the third coiled sheet 44. It is noted that the shape of the sensing plate section 46 is not restricted. According to the practical requirements, the sensing plate section 46 with any desired shape may be cut by the cutting device 39. Moreover, the profiles and the sizes of the first coiled sheet 42, the second coiled sheet 43 as shown in FIG. 10 are presented herein for purpose of illustration and description only, and are not restricted.

The laminated structure of the first coiled sheet 42, the second coiled sheet 43, the third coiled sheet 44 and the fourth coiled sheet 45 is continuously moved in the direction X. When the laminated structure of the first coiled sheet 42, the second coiled sheet 43, the third coiled sheet 44 and the fourth coiled sheet 45 is moved to the washing device 40, the contaminants (e.g. dust) which are occurred at the time of cutting task and retained on the first coiled sheet 42, the second coiled sheet 43, the third coiled sheet 44 and the fourth coiled sheet 45 are cleaned away by the washing device 40 (Step S31).

After the washing task is completed, the laminated structure of the first coiled sheet 42, the second coiled sheet 43, the third coiled sheet 44 and the fourth coiled sheet 45 is moved to in the direction X. When the laminated structure of the first coiled sheet 42, the second coiled sheet 43, the third coiled sheet 44 and the fourth coiled sheet 45 is moved to the removing device 41, the sensing plate section 46 is removed from the laminated structure of the first coiled sheet 42, the second coiled sheet 43, the third coiled sheet 44 and the fourth coiled sheet 45. After the sensing plate section 46 is removed, a corresponding sensing plate 47 is produced (Step S41). The sensing plate 47 is shown in FIG. 11.

Then, the sensing plate 47 is transmitted from the removing device 41 to a platform (not shown). Then, a touch control circuit board 48 is attached on the sensing plate 47 at a part of the first coiled sheet 42 (see the step S51 and FIG. 12). Consequently, the touch control circuit board 48 and the sensing region 421 are electrically connected with each other.

Then, the step S61 is performed to move the sensing plate 47 and the touch control circuit board 48 to another platform and test whether the sensing plate 47 and the touch control circuit board 48 are normal.

FIG. 13 schematically illustrates the combination of the sensing plate, the touch control circuit board and a glass plate produced in the touch panel producing method according to the second embodiment of the present invention. If the test result is qualified, a bonding surface of the sensing plate 47 (e.g. a part of the fourth coiled sheet 45) is attached on a glass plate 49. It is noted that the sensing plate 47 of this embodiment may be attached on the display panel 22 of the first embodiment. Alternatively, the sensing plate 20 of the first embodiment may be attached on the glass plate 49 of this embodiment.

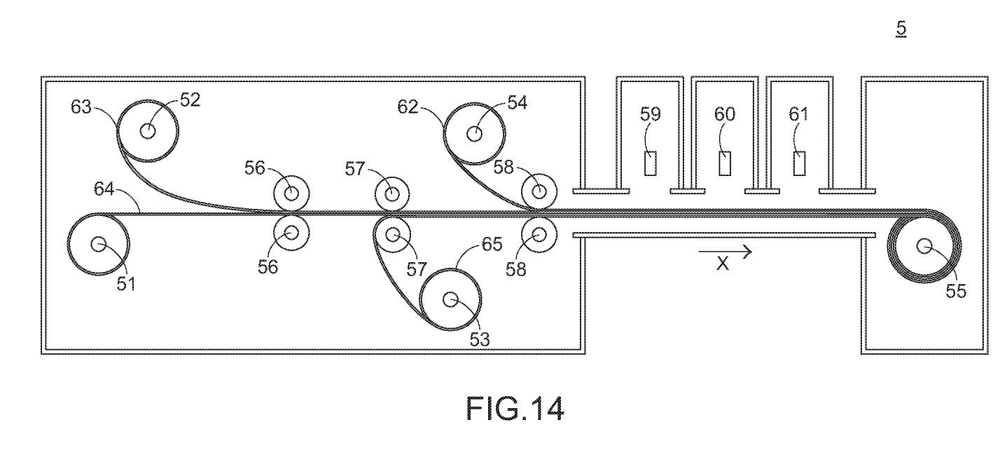

Hereinafter, a touch panel producing method according to a third embodiment of the present invention will be illustrated with reference to FIG. 14. FIG. 14 schematically illustrates a touch panel producing apparatus for implementing a touch panel producing method according to a third embodiment of the present invention. As shown in FIG. 14, the touch panel producing apparatus 5 comprises a first shaft 51, a second shaft 52, a third shaft 53, a fourth shaft 54, a take-up roll 55, a first roller assembly 56, a second roller assembly 57, a third roller assembly 58, a cutting device 59, a washing device 60, and a removing device 61. Except for the following items, the components and arrangements of the touch panel producing apparatus 5 of this embodiment are substantially identical to those of the touch panel producing apparatus 3 of the second embodiment.

A third coiled sheet 64 is sheathed around the first shaft 51. A second coiled sheet 63 is sheathed around the second shaft 52. A fourth coiled sheet 65 is sheathed around the third shaft 53. A first coiled sheet 62 is sheathed around the fourth shaft 54. The configurations of the first coiled sheet 62, the second coiled sheet 63, the third coiled sheet 64 and the fourth coiled sheet 65 of this embodiment are identical to those of the first coiled sheet 42, the second coiled sheet 43, the third coiled sheet 44 and the fourth coiled sheet 45 of the second embodiment. In comparison with the touch panel producing method of the second embodiment, the sequence of attaching the first coiled sheet 62, the second coiled sheet 63, the third coiled sheet 64 and the fourth coiled sheet 65 is distinguished. However, the stacking sequence of the first coiled sheet 62, the second coiled sheet 63, the third coiled sheet 64 and the fourth coiled sheet 65 is the same as the stacking sequence of the second embodiment.

Alternatively, the sequence of attaching the second coiled sheet 63 and the fourth coiled sheet 65 may be exchanged. However, the second shaft 52 and second coiled sheet 63 are still located above the third coiled sheet 64, and the third shaft 53 and the fourth coiled sheet 65 are still located below the third coiled sheet 64.

Alternatively, the sequence of attaching the fourth coiled sheet 65 and the first coiled sheet 62 may be exchanged. However, the third shaft 53 and the fourth coiled sheet 65 are still located below the third coiled sheet 64, and the fourth shaft 54 and the first coiled sheet 62 are still located above the third coiled sheet 64.

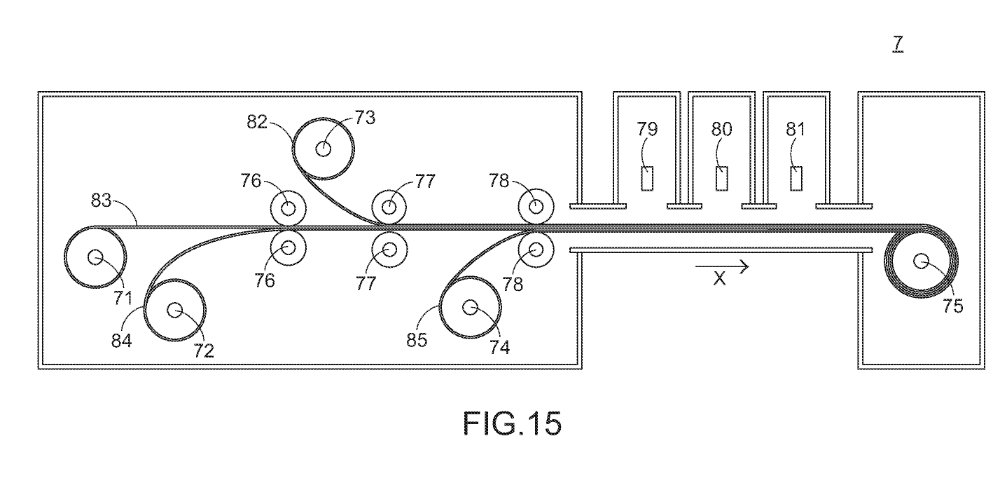

Hereinafter, a touch panel producing method according to a fourth embodiment of the present invention will be illustrated with reference to FIG. 15. FIG. 15 schematically illustrates a touch panel producing apparatus for implementing a touch panel producing method according to a fourth embodiment of the present invention. As shown in FIG. 15, the touch panel producing apparatus 7 comprises a first shaft 71, a second shaft 72, a third shaft 73, a fourth shaft 74, a take-up roll 75, a first roller assembly 76, a second roller assembly 77, a third roller assembly 78, a cutting device 79, a washing device 80, and a removing device 81. Except for the following items, the components and arrangements of the touch panel producing apparatus 7 of this embodiment are substantially identical to those of the touch panel producing apparatus 3 of the second embodiment.

A second coiled sheet 83 is sheathed around the first shaft 71. A third coiled sheet 84 is sheathed around the second shaft 72. A first coiled sheet 82 is sheathed around the third shaft 73. A fourth coiled sheet 85 is sheathed around the fourth shaft 74. The configurations of the first coiled sheet 82, the second coiled sheet 83, the third coiled sheet 84 and the fourth coiled sheet 85 of this embodiment are identical to those of the first coiled sheet 42, the second coiled sheet 43, the third coiled sheet 44 and the fourth coiled sheet 45 of the second embodiment. In comparison with the touch panel producing method of the second embodiment, the sequence of attaching the first coiled sheet 82, the second coiled sheet 83, the third coiled sheet 84 and the fourth coiled sheet 85 is distinguished. However, the stacking sequence of the first coiled sheet 82, the second coiled sheet 83, the third coiled sheet 84 and the fourth coiled sheet 85 is the same as the stacking sequence of the second embodiment.

Alternatively, the sequence of attaching the third coiled sheet 84 and the first coiled sheet 82 may be exchanged. However, the second shaft 72 and the third coiled sheet 84 are still located below the second coiled sheet 83, and the third shaft 73 and the first coiled sheet 82 are still located above the second coiled sheet 83.

Alternatively, the sequence of attaching the first coiled sheet 82 and the fourth coiled sheet 85 may be exchanged. However, the third shaft 73 and the first coiled sheet 82 are still located above the second coiled sheet 83, and the fourth shaft 74 and the fourth coiled sheet 85 are still located below the second coiled sheet 83.

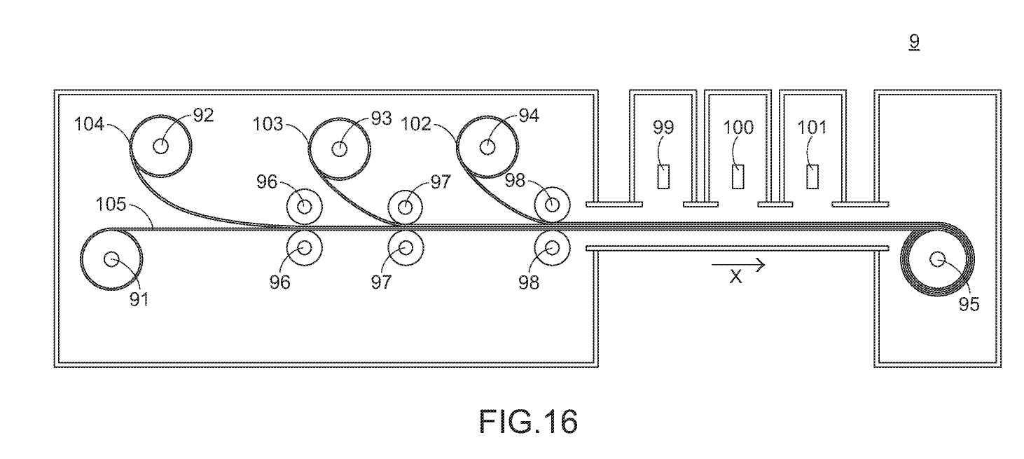

Hereinafter, a touch panel producing method according to a fifth embodiment of the present invention will be illustrated with reference to FIG. 16. FIG. 16 schematically illustrates a touch panel producing apparatus for implementing a touch panel producing method according to a fifth embodiment of the present invention. As shown in FIG. 16, the touch panel producing apparatus 9 comprises a first shaft 91, a second shaft 92, a third shaft 93, a fourth shaft 94, a take-up roll 95, a first roller assembly 96, a second roller assembly 97, a third roller assembly 98, a cutting device 99, a washing device 100, and a removing device 101. Except for the following items, the components and arrangements of the touch panel producing apparatus 9 of this embodiment are substantially identical to those of the touch panel producing apparatus 3 of the second embodiment.

A fourth coiled sheet 105 is sheathed around the first shaft 91. A third coiled sheet 104 is sheathed around the second shaft 92. A second coiled sheet 103 is sheathed around the third shaft 93. A first coiled sheet 102 is sheathed around the fourth shaft 94. The configurations of the first coiled sheet 102, the second coiled sheet 103, the third coiled sheet 104 and the fourth coiled sheet 105 of this embodiment are identical to those of the first coiled sheet 42, the second coiled sheet 43, the third coiled sheet 44 and the fourth coiled sheet 45 of the second embodiment. In comparison with the touch panel producing method of the second embodiment, the sequence of attaching the first coiled sheet 102, the second coiled sheet 103, the third coiled sheet 104 and the fourth coiled sheet 105 is distinguished. However, the stacking sequence of the first coiled sheet 102, the second coiled sheet 103, the third coiled sheet 104 and the fourth coiled sheet 105 is the same as the stacking sequence of the second embodiment.

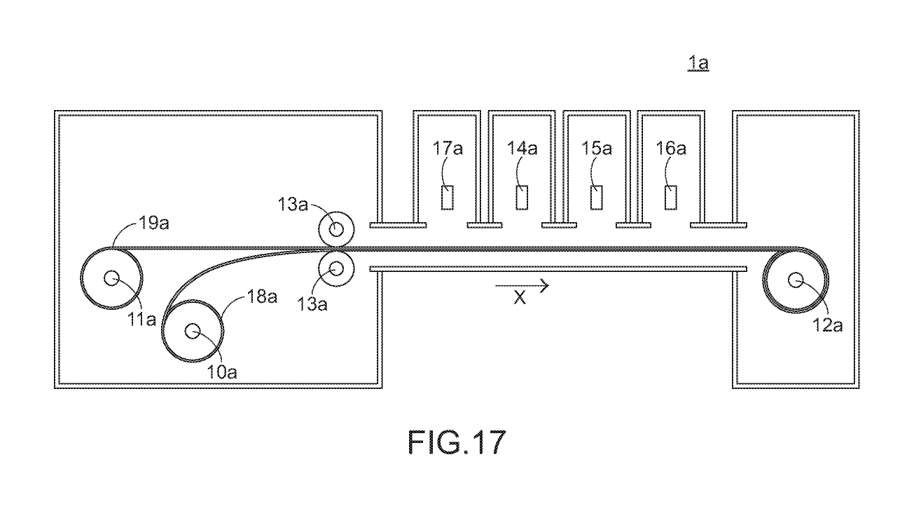

Hereinafter, a touch panel producing method according to a sixth embodiment of the present invention will be illustrated with reference to FIG. 17. FIG. 17 schematically illustrates a touch panel producing apparatus for implementing a touch panel producing method according to a sixth embodiment of the present invention. As shown in FIG. 17, the touch panel producing apparatus 1a comprises a first shaft 10a, a second shaft 11a, a take-up roll 12a, a first roller assembly 13a, a cutting device 14a, a washing device 15a, a removing device 16a, and an attaching device 17a.

A first coiled sheet 18a is sheathed around the first shaft 10a. A second coiled sheet 19a is sheathed around the second shaft 11a. The second shaft 11a is located above the first shaft 10a. The configurations of the first coiled sheet 18a and the second coiled sheet 19a are identical to those of the first coiled sheet 17 and the second coiled sheet 18 of the first embodiment, and are not redundantly described herein.

Moreover, the first roller assembly 13a, the attaching device 17a, the cutting device 14a, the washing device 15a, the removing device 16a and the take-up roll 12a are sequentially arranged downstream of the first shaft 10a and the second shaft 11a. The cutting device 14a, the washing device 15a and the removing device 16a are identical to those of the first embodiment. An example of the attaching device 17a is an automatic device such as an ACF machine, but is not limited thereto.

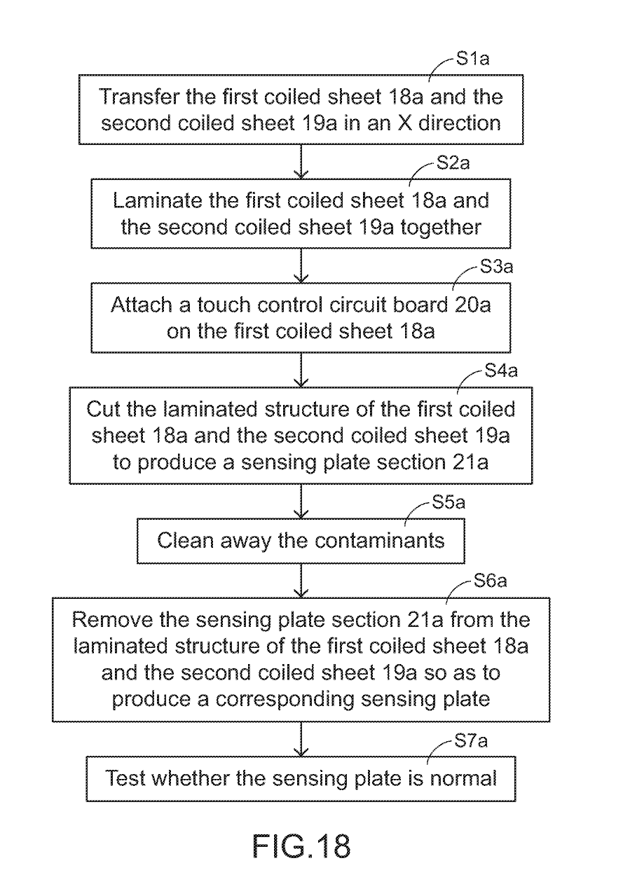

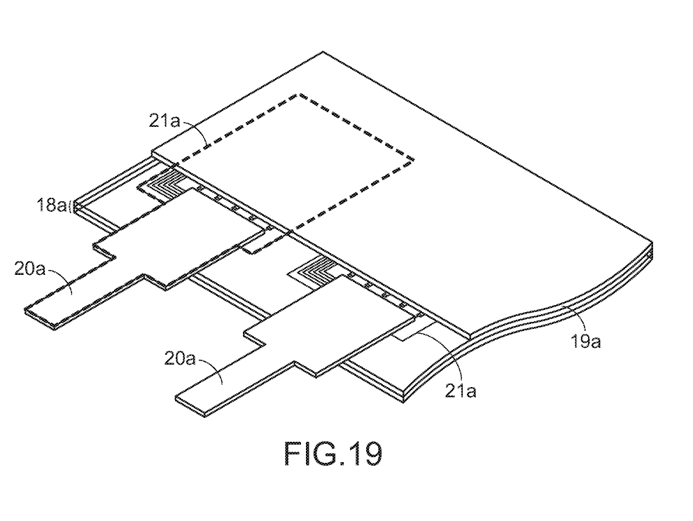

Hereinafter, the operations of the touch panel producing method according to the sixth embodiment of the present invention will be illustrated with reference to FIGS. 18 and 19. FIG. 18 schematically illustrates a flowchart of the touch panel producing method according to a sixth embodiment of the present invention. FIG. 19 schematically illustrates a sensing plate section generated in the touch panel producing method according to the sixth embodiment of the present invention. In comparison with the touch panel producing method of the first embodiment, the step of attaching a touch control circuit board 20a is prior to the cutting step.

Firstly, the first shaft 10a and the second shaft 11a are rotated to transfer the first coiled sheet 18a and the second coiled sheet 19a in an X direction (Step S1a of FIG. 18), and the first coiled sheet 18a and the second coiled sheet 19a are laminated together by the first roller assembly 13a (Step S2a of FIG. 18).

Then, a laminated structure of the first coiled sheet 18a and the second coiled sheet 19a is moved to the attaching device 17a. By the attaching device 17a, a touch control circuit board 20a is attached on the first coiled sheet 18a (Step S3a). In this embodiment, the touch control circuit board 20a is a flexible printed circuit board (FPC). In addition, the touch control circuit board 20a may be attached on the first coiled sheet 18a through an anisotropic conductive film (ACF) or any other appropriate adhesive sheet.

Then, the laminated structure of the first coiled sheet 18a and the second coiled sheet 19a is moved to the cutting device 14a. The laminated structure of the first coiled sheet 18a and the second coiled sheet 19a is cut by the cutting device 14a. Consequently, a sensing plate section 21a is generated (Step S4a).

As shown in FIG. 19, the sensing plate section 21a (as shown in dotted lines) comprises a part of the first coiled sheet 18a, a part of the second coiled sheet 19a attached on the first coiled sheet 18a, and the touch control circuit board 20a attached on the first coiled sheet 18a. It is noted that the shape of the sensing plate section 21a is not restricted. According to the practical requirements, the sensing plate section 21a with any desired shape may be cut by the cutting device 14a. Moreover, the profiles and the sizes of the first coiled sheet 18a and the second coiled sheet 19a as shown in FIG. 19 are presented herein for purpose of illustration and description only and are not restricted.

Then, the laminated structure of the first coiled sheet 18a and the second coiled sheet 19a and the touch control circuit board 20a are moved to the washing device 15a, and the retained contaminants are cleaned away by the washing device 15a (Step S5a). Then, the laminated structure of the first coiled sheet 18a and the second coiled sheet 19a and the touch control circuit board 20a are moved to the removing device 16a, and the sensing plate section 21a is removed by the removing device 16a. Consequently, a corresponding sensing plate is produced (Step S6a). The structure of the sensing plate of this embodiment is identical to that of the sensing plate of FIG. 6, and is not redundantly described herein.

Then, the step S7a is performed to transmit the sensing plate from the removing device 16a to a platform (not shown) and test whether the sensing plate is normal. If the test result is qualified, a bonding surface of the sensing plate (e.g. a part of the second coiled sheet 19a) is attached on a display panel or a glass plate.

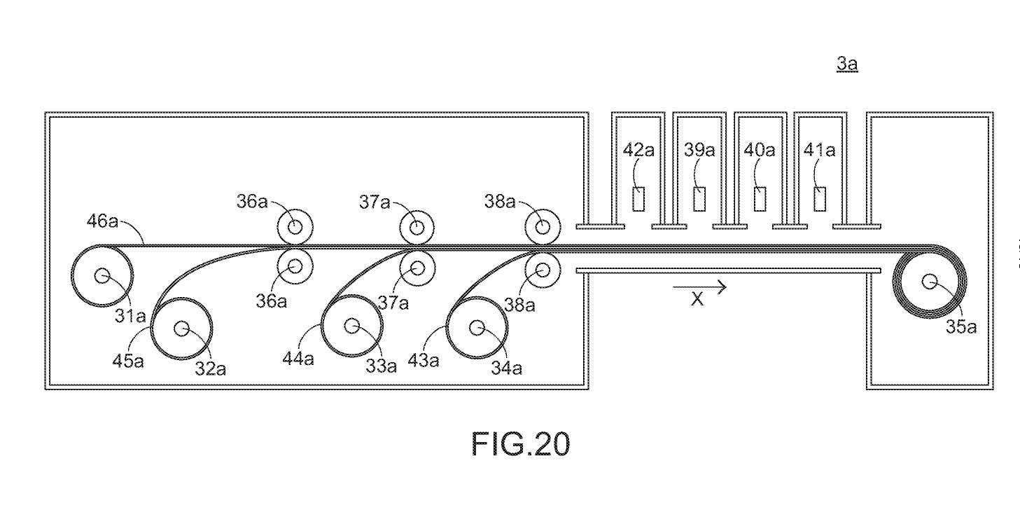

Hereinafter, a touch panel producing method according to a seventh embodiment of the present invention will be illustrated with reference to FIG. 20. FIG. 20 schematically illustrates a touch panel producing apparatus for implementing a touch panel producing method according to a seventh embodiment of the present invention.

As shown in FIG. 20, the touch panel producing apparatus 3a comprises a first shaft 31a, a second shaft 32a, a third shaft 33a, a fourth shaft 34a, a take-up roll 35a, a first roller assembly 36a, a second roller assembly 37a, a third roller assembly 38a, a cutting device 39a, a washing device 40a, a removing device 41a, and an attaching device 42a.

A fourth coiled sheet 46a is sheathed around the first shaft 31a. A third coiled sheet 45a is sheathed around the second shaft 32a. A second coiled sheet 44a is sheathed around the third shaft 33a. A first coiled sheet 43a is sheathed around the fourth shaft 34a. The configurations of the third coiled sheet 45a and the fourth coiled sheet 46a are identical to those of the third coiled sheet 44 and the fourth coiled sheet 45 of the second embodiment, and the configurations of the first coiled sheet 43a and the second coiled sheet 44a are identical to those of the first coiled sheet 17 and the second coiled sheet 18 of the first embodiment, and are not redundantly described herein.

The first roller assembly 36a is arranged downstream of the first shaft 31a and the second shaft 32a. The second roller assembly 37a is arranged downstream of the third shaft 33a. The third roller assembly 38a is arranged downstream of the fourth shaft 34a. The attaching device 42a, the cutting device 39a, the washing device 40a, the removing device 41a and the take-up roll 35a are sequentially arranged downstream of the third roller assembly 38a. The structures and the functions of the cutting device 39a, the washing device 40a and the removing device 41a of this embodiment are identical to those of the first embodiment, and the structures and the functions of the attaching device 42a are identical to those of the sixth embodiment, and are not redundantly described herein.

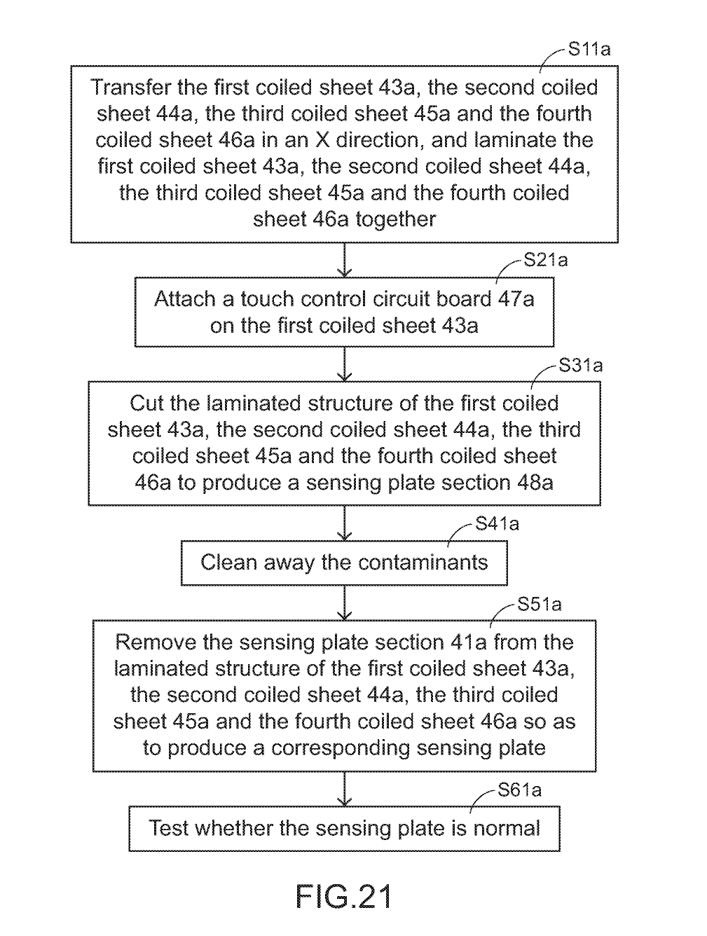

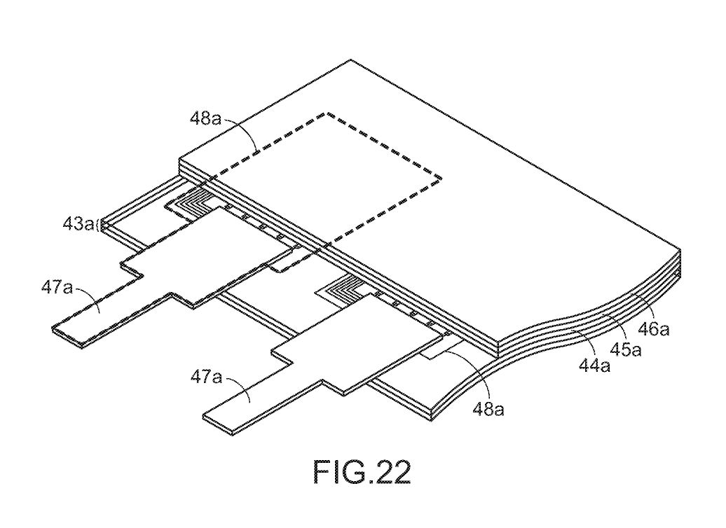

Hereinafter, the operations of the touch panel producing method according to the seventh embodiment of the present invention will be illustrated with reference to FIGS. 21 and 22. FIG. 21 schematically illustrates a flowchart of the touch panel producing method according to a seventh embodiment of the present invention. FIG. 22 schematically illustrates a sensing plate section generated in the touch panel producing method according to the seventh embodiment of the present invention. In comparison with the touch panel producing method of the second embodiment, the step of attaching a touch control circuit board 47a is prior to the cutting step.

Firstly, the step S11a is performed. After the first coiled sheet 43a, the second coiled sheet 44a, the third coiled sheet 45a and the fourth coiled sheet 46a are sheathed around the first shaft 31a, the second shaft 32a, the third shaft 33a and the fourth shaft 34a, respectively, the first shaft 31a, the second shaft 32a, the third shaft 33a and the fourth shaft 34a are rotated to transfer the first coiled sheet 43a, the second coiled sheet 44a, the third coiled sheet 45a and the fourth coiled sheet 46a in an X direction. Then, the first coiled sheet 43a, the second coiled sheet 44a, the third coiled sheet 45a and the fourth coiled sheet 46a are laminated together by the first roller assembly 36a, the second roller assembly 37a and the third roller assembly 38a.

Then, a laminated structure of the first coiled sheet 43a, the second coiled sheet 44a, the third coiled sheet 45a and the fourth coiled sheet 46a is moved to the attaching device 42a. By the attaching device 42a, a touch control circuit board 47a is attached on the first coiled sheet 43a (Step S21a). In this embodiment, the touch control circuit board 47a is a flexible printed circuit board (FPC). In addition, the touch control circuit board 47a may be attached on the first coiled sheet 43a through an anisotropic conductive film (ACF) or any other appropriate adhesive sheet.

Then, the laminated structure of the first coiled sheet 43a, the second coiled sheet 44a, the third coiled sheet 45a and the fourth coiled sheet 46a is moved to the cutting device 39a. The laminated structure of the first coiled sheet 43a, the second coiled sheet 44a, the third coiled sheet 45a and the fourth coiled sheet 46a is cut by the cutting device 39a. Consequently, a sensing plate section 48a is generated (Step S31a).

As shown in FIG. 22, the sensing plate section 48a (as shown in dotted lines) comprises a part of the first coiled sheet 43a, a part of the second coiled sheet 44a attached on the first coiled sheet 43a, a part of the third coiled sheet 45a attached on the second coiled sheet 44a, a part of the fourth coiled sheet 46a attached on the third coiled sheet 45a, and the touch control circuit board 47a attached on the first coiled sheet 43a. It is noted that the shape of the sensing plate section 48a is not restricted. According to the practical requirements, the sensing plate section 48a with any desired shape may be cut by the cutting device 39a. Moreover, the profiles and the sizes of the first coiled sheet 43a, the second coiled sheet 44a, the third coiled sheet 45a and the fourth coiled sheet 46a as shown in FIG. 22 are presented herein for purpose of illustration and description only and are not restricted.

Then, the laminated structure of the first coiled sheet 43a, the second coiled sheet 44a, the third coiled sheet 45a and the fourth coiled sheet 46a and the touch control circuit board 47a are moved to the washing device 40a, and the retained contaminants are cleaned away by the washing device 40a (Step S41a). Then, the laminated structure of the first coiled sheet 43a, the second coiled sheet 44a, the third coiled sheet 45a and the fourth coiled sheet 46a and the touch control circuit board 47a are moved to the removing device 41a, and the sensing plate section 41a is removed by the removing device 41a. Consequently, a corresponding sensing plate is produced (Step S51a). The structure of the sensing plate of this embodiment is identical to that of the sensing plate of FIG. 12, and is not redundantly described herein.

Then, the step S61a is performed to transmit the sensing plate from the removing device 41a to a platform (not shown) and test whether the sensing plate is normal. If the test result is qualified, a bonding surface of the sensing plate (e.g. a part of the fourth coiled sheet 46a) is attached on a display panel or a glass plate.

From the above descriptions, the present invention provides a touch panel producing method. After plural coiled sheets are attached on each other by a roll-to-roll process, automatic devices are used to performing a cutting task, a removing task, a task of attaching a touch control circuit board, a cleaning task and a testing task. Consequently, a touch panel is fabricated. In other words, the touch panel producing method of the present invention can be automatically implemented without the manual attaching procedures.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A touch panel producing method, comprising steps of:
transferring a first coiled sheet and a second coiled sheet in a specified direction, wherein the first coiled sheet comprises plural sensing regions, and the second coiled sheet is an adhesive sheet;
laminating the first coiled sheet and the second coiled sheet together;
cutting a laminated structure of the first coiled sheet and the second coiled sheet, thereby producing a sensing plate section, wherein the sensing plate section comprises one of the plural sensing regions;
removing the sensing plate section from the laminated structure of the first coiled sheet and the second coiled sheet, thereby producing a sensing plate; and
attaching a touch control circuit board on the sensing plate.

2. The touch panel producing method according to claim 1, wherein after the step of cutting the laminated structure of the first coiled sheet and the second coiled sheet, the touch panel producing method further comprises a step of cleaning away contaminants from the first coiled sheet and the second coiled sheet.

3. The touch panel producing method according to claim 1, wherein after the step of attaching the touch control circuit board on the sensing plate, the touch panel producing method further comprises a step of testing whether the sensing plate and the touch control circuit board are normal.

4. The touch panel producing method according to claim 1, wherein the first coiled sheet comprises a plastic substrate, and the plural sensing regions are formed on a first surface of the plastic substrate.

5. The touch panel producing method according to claim 4, wherein each of the plural sensing regions is made of nano carbon tube, nano silver, or graphene.

6. The touch panel producing method according to claim 4, wherein an explosion-proof film, a scratch-resistant film or an anti-glare film is disposed on a second surface of the plastic substrate.

7. The touch panel producing method according to claim 1, wherein the second coiled sheet is an optically-clear adhesive sheet or a pressure-sensitive adhesive sheet.

8. The touch panel producing method according to claim 1, wherein after the step of attaching the touch control circuit board on the sensing plate, the touch panel producing method further comprises a step of attaching the sensing plate on a glass plate or a display panel.

9. The touch panel producing method according to claim 8, wherein the display panel is a liquid crystal display panel, an electronic paper display panel or a flexible display panel.

10. A touch panel producing method, comprising steps of:
transferring a first coiled sheet, a second coiled sheet, a third coiled sheet and a fourth coiled sheet in a specified direction, and laminating the first coiled sheet, the second coiled sheet, the third coiled sheet and the fourth coiled sheet together, wherein the first coiled sheet is attached on the second coiled sheet, the second coiled sheet is attached on the third coiled sheet, and the third coiled sheet is attached on the fourth coiled sheet, wherein the first coiled sheet comprises plural sensing regions, the second coiled sheet and the fourth coiled sheet are adhesive sheets, and the third coiled sheet is a light guide plate;
cutting a laminated structure of the first coiled sheet, the second coiled sheet, the third coiled sheet and the fourth coiled sheet, thereby producing a sensing plate section, wherein the sensing plate section comprises one of the plural sensing regions;
removing the sensing plate section from the laminated structure of the first coiled sheet, the second coiled sheet, the third coiled sheet and the fourth coiled sheet, thereby producing a sensing plate; and
attaching a touch control circuit board on the sensing plate.

11. The touch panel producing method according to claim 10, wherein after the step of cutting the laminated structure of the first coiled sheet, the second coiled sheet, the third coiled sheet and the fourth coiled sheet, the touch panel producing method further comprises a step of cleaning away contaminants from the first coiled sheet, the second coiled sheet, the third coiled sheet and the fourth coiled sheet.

12. The touch panel producing method according to claim 10, wherein after the step of attaching the touch control circuit board on the sensing plate, the touch panel producing method further comprises a step of testing whether the sensing plate and the touch control circuit board are normal.

13. The touch panel producing method according to claim 10, wherein the first coiled sheet comprises a plastic substrate, and the plural sensing regions are formed on a first surface of the plastic substrate.

14. The touch panel producing method according to claim 13, wherein an explosion-proof film, a scratch-resistant film or an anti-glare film is disposed on a second surface of the plastic substrate.

15. The touch panel producing method according to claim 10, wherein the third coiled sheet is made of polycarbonate, polymethylmethacrylate, polyethylene terephthalate or silicon resin.

16. The touch panel producing method according to claim 10, wherein the fourth coiled sheet is an optically-clear adhesive sheet or a liquid optically-clear adhesive sheet.

17. The touch panel producing method according to claim 10, wherein after the step of attaching the touch control circuit board on the sensing plate, the touch panel producing method further comprises a step of attaching the sensing plate on a glass plate or a display panel.

18. A touch panel producing method, comprising steps of:
transferring a first coiled sheet and a second coiled sheet in a specified direction, wherein the first coiled sheet comprises plural sensing regions, and the second coiled sheet is an adhesive sheet;
laminating the first coiled sheet and the second coiled sheet together;
attaching a touch control circuit board on the first coiled sheet;
cutting a laminated structure of the first coiled sheet and the second coiled sheet, thereby producing a sensing plate section, wherein the sensing plate section comprises one of the plural sensing regions and the touch control circuit board; and
removing the sensing plate section from the laminated structure of the first coiled sheet and the second coiled sheet, thereby producing a sensing plate.

19. A touch panel producing method, comprising steps of:
transferring a first coiled sheet, a second coiled sheet, a third coiled sheet and a fourth coiled sheet in a specified direction, and laminating the first coiled sheet, the second coiled sheet, the third coiled sheet and the fourth coiled sheet together, wherein the first coiled sheet is attached on the second coiled sheet, the second coiled sheet is attached on the third coiled sheet, and the third coiled sheet is attached on the fourth coiled sheet, wherein the first coiled sheet comprises plural sensing regions, the second coiled sheet and the fourth coiled sheet are adhesive sheets, and the third coiled sheet is a light guide plate;
attaching a touch control circuit board on the first coiled sheet;
cutting a laminated structure of the first coiled sheet, the second coiled sheet, the third coiled sheet and the fourth coiled sheet, thereby producing a sensing plate section, wherein the sensing plate section comprises one of the plural sensing regions and the touch control circuit board; and
removing the sensing plate section from the laminated structure of the first coiled sheet, the second coiled sheet, the third coiled sheet and the fourth coiled sheet, thereby producing a sensing plate.
